(19) United States
(12) Patent Application Publication
(10) Pub. No.: US 2025/0243358 A1
(43) Pub. Date: Jul. 31, 2025

(54) COMPOSITION COMPRISING A MULTISTAGE POLYMER AND A (METH)ACRYLIC POLYMER, ITS METHOD OF PREPARATION AND ITS USE

(71) Applicant: Arkema France, Colombes (FR)

(72) Inventors: Alexandre VERMOGEN, PIERRE-BENITE CEDEX (FR); Aline COUFFIN, LACQ (FR); Rabi INOUBLI, PIERRE-BENITE CEDEX (FR)

(73) Assignee: Arkema France, Colombes (FR)

(21) Appl. No.: 18/855,683

(22) PCT Filed: Apr. 11, 2023
(86) PCT No.: PCT/EP2023/059459

§ 371 Date: Oct. 10, 2024

(30) Foreign Application Priority Data
Apr. 12, 2022 (FR) FR2203352

(51) Int. Cl. C08L 63/00; C08J 3/22; C09D 7/40; C09D 7/65; C09D 163/00; C09J 11/08; C09J 163/00

(52) U.S. Cl. CPC C08L 63/00; C08J 3/226; C09D 7/65; C09D 7/70; C09D 163/00; C09J 11/08; C09J 163/00; C08J 2363/02; C08J 2433/10; C08L 2205/03; C08L 2207/53; C08L 2310/00

(57) ABSTRACT

The present invention relates to a composition comprising a multistage polymer, a (meth)acrylic polymer and a monomer or prepolymer, its process of preparation and its use.

In particular the present invention relates to a process for preparing a composition comprising a multistage polymer in form of polymeric particles, a (meth)acrylic polymer, and a monomer or prepolymer.

More particularly the present invention relates to a liquid polymer composition comprising a multistage polymer, a (meth)acrylic polymer and a monomer or prepolymer, its process of preparation, its use particularly as a masterbatch.

### FIELD OF THE INVENTION

The present invention relates to a composition comprising a multistage polymer, a (meth)acrylic polymer and a monomer or prepolymer, its process of preparation and its use.

In particular the present invention relates to a process for preparing a composition comprising a multistage polymer in form of polymeric particles, a (meth)acrylic polymer, and a monomer or prepolymer.

More particularly the present invention relates to a liquid polymer composition comprising a multistage polymer, a (meth)acrylic polymer and a monomer or prepolymer, its process of preparation, its use particularly as a masterbatch.

### Technical Problem

Polymers are widely used also as additives in polymer compositions. These so called polymer additives are usually added as granulate or also as powder, either to solid polymers, or to molten polymers or to liquid resins or to liquid compositions.

One class of polymeric additives are processing aids, another one are polymeric impact modifiers.

Polymeric impact modifiers can be in form of polymeric particles. Usually these polymeric impact modifiers are in form of core-shell particles that are made by a multistage process, with at least one stage comprising a rubber like polymer. Afterwards these particles are incorporated in the polymers or polymer compositions, in order to increase their impact resistance. The polymers or polymer compositions can be thermoset ones or thermoplastic ones.

Thermosetting polymers consist of crosslinked three-dimensional structures. The crosslinking is obtained by curing reactive groups inside the so-called prepolymer. Curing for example can be obtained by heating the polymer chains or prepolymer in order to crosslink and harden the material permanently.

Thermoplastic polymers consist of linear or branched polymers, which are usually not cross-linked. They might be slightly cross-linked as long as they can be deformed by heat.

However, these before mentioned core-shell particles are not easily to disperse or fast to disperse in all kind of resins or polymers or precursors to polymers, especially for example in liquid epoxy resins or liquid monomers or other liquid polymeric precursors. A good homogenous and fast dispersion is necessary for having satisfying impact performance in the final polymeric composition. An easy dispersion making and fast dispersion time is also required to reduce the process time and gain on an easier simpler process. The concentration of the core-shell particles should also be high, so that the compositions can be used as masterbatches.

An objective of the present invention is to propose a composition comprising precursors for thermoset polymers or thermoplastic polymers comprising a multistage polymer.

An additional objective of the present invention is to propose a composition comprising precursors for thermoset polymers or thermoplastic polymers comprising a high amount of a multistage polymer. By high amount is meant at least at least 10 phr of multistage polymer comprising composition in view of the precursors (for example for 100 parts of epoxy prepolymer or monomer).

An objective of the present invention is also to propose a composition comprising precursors for thermoset polymers or thermoplastic polymers comprising a multistage polymer that is stable with the time. The stability with time means, that no visible macroscopic phase separation occurs, preferably for a period of at least 1 month.

Another objective of the present invention is to propose a process for making a composition comprising precursors for thermoset polymers or thermoplastic polymers and a multistage polymer.

Still another objective of the present invention is a process for manufacturing a composition comprising precursors for thermoset polymers or thermoplastic polymers comprising a high amount of a multistage polymer.

Still another objective of the present invention is a process for manufacturing a composition comprising precursors for thermoset polymers or thermoplastic polymers comprising a multistage polymer in a short time.

Still another objective of the present invention is a process for manufacturing a composition comprising precursors for thermoset polymers or thermoplastic polymers comprising a multistage polymer that is stable over time and has a sufficient storage live without separation.

Still another objective of the present invention is the use of a composition comprising precursors for thermoset polymers or thermoplastic polymers and a multistage polymer as a masterbatch.

Still another objective is to provide a process to reduce the time of dispersing a multistage polymer in a composition comprising precursors for thermoset polymers or thermoplastic polymers.

### BACKGROUND OF THE INVENTION

### Prior Art

The document WO2016/102682 discloses a multistage polymer composition and its method of preparation. The multistage polymer comprises a last stage that comprises a (meth) acrylic polymer that has a mass average molecular weight of less than 100 000 g/mol

The document EP 1 632 533 describes a process for producing modified epoxy resin. The epoxy resin composition is having rubber like polymer particles dispersed in it, by a process that brings the particles in contact with an organic medium that disperses the rubber particles.

The document EP 1 666 519 discloses a process for producing rubbery polymer particle and process for resin composition containing the same.

The document EP 2 123 711 discloses a thermosetting resin composition having a rubbery polymer particles dispersed therein and process for production thereof.

The document WO2017/121479 discloses a liquid composition comprising a monomer, a (meth)acrylic polymer and a multistage polymer.

The document WO2019/012052 discloses a composition comprising a multistage polymer and its method of preparation. The composition comprises as well a (meth) acrylic polymer that has a mass average molecular weight between 100 000 g/mol and 1 000 000 g/mol.

None of the cited prior art documents discloses such a masterbatch composition nor especially a process for preparing it.

### BRIEF DESCRIPTION OF THE INVENTION

Surprisingly it has been found that a composition (C1) comprising
a) 100 phr of a composition (C2) comprising a monomer (M1) or a prepolymer (PRE1) or a mixture of both,
b) between 10 phr and 100 phr of a polymeric composition (PC1) comprising
   b1) one stage (SB1) comprising a polymer (B1) having a glass transition temperature of less than 10° C.,
   b2) one stage (SB2) comprising a polymer (B2) having a glass transition temperature of at least 60° C., and
   b3) and a polymer (B3) having a glass transition temperature of at least 30° C., said polymer (B3) represents at most 40 wt % of the composition based on b1), b2) and b3) only;
      characterized in that at least the component b1) and the component b2) of composition (PC1) are part of a multistage polymer (MP1), and characterized in that the polymer (B3) has a mass average molecular weight Mw between 10 000 g/mol and 500 000 g/mol; can be easily and rapidly prepared and used as a masterbatch.

Surprisingly it has also been found that a process for manufacturing a composition (C1) comprising the steps of:
a) providing a composition (C2) comprising a monomer (M1) or a prepolymer (PRE1) or a mixture of both;
b) providing a polymeric composition (PC1) comprising
   b1) one stage (SB1) comprising a polymer (B1) having a glass transition temperature of less than 10° C.,
   b2) one stage (SB2) comprising a polymer (B2) having a glass transition temperature of at least 60° C., and
   b3) and a polymer (B3) having a glass transition temperature of at least 30° C., said polymer (B3) represents at most 40 wt % of the composition based on b1), b2) and b3) only;
c) bringing into contact the provided components of a) and b);
d) providing mixing means;
e) mixing the components with the provided mixing means,
   characterized in that at least the component b1) and the component b2) of composition (PC1) are part of a multistage polymer (MP1), and characterized in that the polymer (B3) has a mass average molecular weight Mw between 10 000 g/mol and 500 000 g/mol; yields to a homogenous stable composition (C1) comprising between 10 phr and 100 phr of a polymeric composition (PC1) for 100 parts of composition (C2) comprising monomer (M1) or a prepolymer (PRE1) or a mixture of both.

Surprisingly it has also been found that a method for manufacturing a composition (C1) comprising the steps of
a) providing a polymeric composition (PC1) comprising
   b1) one stage (SB1) comprising a polymer (B1) having a glass transition temperature of less than 10° C.,
   b2) one stage (SB2) comprising a polymer (B2) having a glass transition temperature of at least 60° C., and
   b3) and a polymer (B3) having a glass transition temperature of at least 30° C. and having a mass average molecular weight Mw between 10 000 g/mol and 500 000 g/mol, said polymer (B3) represents at most 40 wt % of the composition based on b1),
   b2) and b3) only,
b) bringing into contact the polymeric composition (PC1) with a composition (C2) comprising a monomer (M1) or a prepolymer (PRE1),
c) providing mixing means,
d) mixing the components brought into contact with the provided mixing means;
   yields to a composition (C1) where the polymeric composition (PC1) is homogenously and faster dispersed in the composition (C2) as compared to a composition not comprising the polymer (B3).

Surprisingly it has additionally been found a process to reduce the time of dispersing a polymeric composition (PC1) in a composition (C2) comprising the steps of:
a) providing a polymeric composition (PC1) comprising
   b1) one stage (SB1) comprising a polymer (B1) having a glass transition temperature of less than 10° C.,
   b2) one stage (SB2) comprising a polymer (B2) having a glass transition temperature of at least 60° C., and
   b3) and a polymer (B3) having a glass transition temperature of at least 30° C. and having a mass average molecular weight Mw between 10 000 g/mol and 500 000 g/mol, said polymer (B3) represents at most 40 wt % of the composition based on b1),
   b2) and b3) only,
b) bringing into contact the polymeric composition (PC1) with a composition (C2),
   which is faster than the same process using a polymeric composition without compound b3).

### DETAILED DESCRIPTION OF THE INVENTION

According to a first aspect, the present invention relates to a composition (C1) comprising
a) 100 phr of a composition (C2) comprising a monomer (M1) or a prepolymer (PRE1) or a mixture of both,
b) between 10 phr and 100 phr of a polymeric composition (PC1)
   b1) one stage (SB1) comprising a polymer (B1) having a glass transition temperature of less than 10° C.,
   b2) one stage (SB2) comprising a polymer (B2) having a glass transition temperature of at least 60° C., and
   b3) and a polymer (B3) having a glass transition temperature of at least 30° C., said polymer (B3) represents at most 40 wt % of the composition based on b1), b2) and b3) only;
      characterized in that at least the component b1) and the component b2) of composition (PC1) are part of a multistage polymer (MP1), and characterized in that the polymer (B3) has a mass average molecular weight Mw between 10 000 g/mol and 500 000 g/mol.

According to a second aspect, the present invention relates to a process for manufacturing composition (C1), said process is comprising the steps of
a) providing a composition (C2) comprising a monomer (M1) or a prepolymer (PRE1) or a mixture of both;
b) providing a polymeric composition (PC1) comprising
   b1) one stage (SB1) comprising a polymer (B1) having a glass transition temperature of less than 10° C.,
   b2) one stage (SB2) comprising a polymer (B2) having a glass transition temperature of at least 60° C., and
   b3) and a polymer (B3) having a glass transition temperature of at least 30° C., said polymer (B3) represents at most 40 wt % of the composition based on b1), b2) and b3) only;
c) bringing into contact the provided components of a) and b);
d) providing mixing means;
e) mixing the components of a) and b) with the provided mixing means,
   characterized in that at least the component b1) and the component b2) of composition (PC1) are part of a multistage polymer (MP1), and characterized in that the polymer (B3) has a mass average molecular weight Mw between 10 000 g/mol and 500 000 g/mol; and characterized that the quantity of the polymeric composition (PC1) is chosen so that between 10 phr and 100 phr of a polymeric composition (PC1) are in composition (C1) for 100 parts of composition (C2) comprising monomer (M1) or a prepolymer (PRE1) or a mixture of both.

In a third aspect the present invention relates to the use of a polymer composition (C1) comprising
a) 100 phr of a composition (C2) comprising a monomer (M1) or a prepolymer (PRE1)
b) between 10 phr and 100 phr of a polymeric composition (PC1) comprising
   b1) one stage (SB1) comprising a polymer (B1) having a glass transition temperature of less than 10° C.,
   b2) one stage (SB2) comprising a polymer (B2) having a glass transition temperature of at least 60° C., and
   b3) and a polymer (B3) having a glass transition temperature of at least 30° C., said polymer (B3) represents at most 40 wt % of the composition based on b1), b2) and b3) only;
      characterized in that at least the component b1) and the component b2) of composition (PC1) are part of a multistage polymer (MP1), and characterized in that the polymer (B3) has a mass average molecular weight Mw between 10 000 g/mol and 500 000 g/mol; as a masterbatch.

In a fourth aspect the present invention relates to the use of a process for manufacturing a composition (C1), said process is comprising the steps of
a) providing a composition (C2) comprising a monomer (M1) or a prepolymer (PRE1) or a mixture of both;
b) providing a polymeric composition (PC1) comprising
   b1) one stage (SB1) comprising a polymer (B1) having a glass transition temperature of less than 10° C.,
   b2) one stage (SB2) comprising a polymer (B2) having a glass transition temperature of at least 60° C., and
   b3) and a polymer (B3) having a glass transition temperature of at least 30° C., said polymer (B2) represents at most 40 wt % of the composition based on b1), b2) and b3) only;
c) bringing into contact the provided components of a) and b);
d) providing mixing means;
e) mixing the components of a) and b) with the provided mixing means,
   characterized in that at least the component b1) and the component b2) of composition (PC1) are part of a multistage polymer (MP1), and characterized in that the polymer (B3) has a mass average molecular weight Mw between 10 000 g/mol and 500 000 g/mol; and characterized that the quantity of the polymeric composition (PC1) is chosen so that between 10 phr and 100 phr of a polymeric composition (PC1) are in composition (C1) for 100 parts monomer (M1) or a prepolymer (PRE1), for preparing a masterbatch.

In a fifth aspect the present invention relates to a process to reduce the dispersing time of between 10 phr and 100 phr of polymeric composition (PC1) comprising a multistage polymer (MP1) comprising:
b1) one stage (SB1) comprising a polymer (B1) having a glass transition temperature of less than 10° C.,
b2), one stage (SB2) comprising a polymer (B2) having a glass transition temperature of at least 60° C.,
   in 100 parts of a composition (C2) comprising a monomer (M1) or a prepolymer (PRE1) or a mixture of both;
   said process comprises the step of
i) bringing into contact the components
ii) providing mixing means
iii) mixing the components with the provided mixing means;
   characterized in that the composition (PC1) comprises additionally b3) a polymer (B3) having a glass transition temperature of at least 30° C., said polymer (B3) represents at most 40 wt % of the composition based on b1), b2) and b3) only; and characterized in that the polymer (B3) has a mass average molecular weight Mw between 10 000 g/mol and 500 000 g/mol.
   This process of the fifth aspect yields preferably to the composition (C1) of previous aspects.

In a sixth aspect the present invention relates to a process to reduce the time to prepare a masterbatch comprising between 10 phr and 100 phr of polymeric composition (PC1) comprising of a multistage polymer (MP1) comprising
b1) one stage (B1) comprising a polymer (B1) having a glass transition temperature of less than 10° C.,
b2), one stage (B2) comprising a polymer (B2) having a glass transition temperature of at least 60° C.,
   in 100 parts of a composition (C2) comprising a monomer (M1) or a prepolymer (PRE1);
   said process comprises the step of
i) bringing into contact the components
ii) providing mixing means
iii) mixing the components with the provided mixing means;
   characterized in that the composition (PC1) comprises additionally b3) a polymer (B3) having a glass transition temperature of at least 30° C., said polymer (B3) represents at most 40 wt % of the composition based on b1), b2) and b3) only; and characterized in that the polymer (B3) has a mass average molecular weight Mw between 10 000 g/mol and 500 000 g/mol.
   This process of the sixth aspect yields preferably to the composition (C1) of first aspect.

By the term “polymer powder” as used is denoted a polymer in form of a powder comprising powder grains in the range of at least 1 μm, said powder grains are obtained by agglomeration of primary polymer particles comprising polymer or polymers, said primary polymer particles are in the nanometer range.

By the term “primary particle” as used is denoted a spherical polymer particle comprising particle in the nanometer range. Preferably the primary particle has a weight average particle size between 20 nm and 800 nm.

By the term “particle size” as used is denoted the volume average diameter of a particle considered as spherical.

By the term “thermoplastic polymer” as used is denoted a polymer that turns to a liquid or becomes more liquid or less viscous when heated and that can take on new shapes by the application of heat and pressure.

By the term “thermosetting polymer” as used is denoted a prepolymer in a soft, solid or viscous state that changes irreversibly into an infusible, insoluble polymer network by curing.

By the term “epoxy resin” as used is understood any organic compound having at least one functional groups of oxirane type which can be polymerized or cured by ring opening. Various examples of epoxy resins are described in this application.

By the term “masterbatch” as used is understood composition that comprises an additive in high concentration in a carrier material. The additive is dispersed in the carrier material.

By the term “impact modifier” as used is understood a material that once incorporated in a polymeric material increases the impact resistance and toughness of that polymeric material by phase micro domains of a rubbery material or rubber polymer.

By the term “rubber” as used is denoted to the thermodynamic state of the polymer above its glass transition.

By the term “polymer composite” as used is denoted a multicomponent material comprising multiple different phase domains in which at least one type of phase domain is a continuous phase and in which at least one component is a polymer.

By the term “copolymer” as used is denoted that the polymer consists of at least two different monomers.

By “multistage polymer” as used is denoted a polymer formed in sequential fashion by a multi-stage polymerization process. Preferred is a multi-stage emulsion polymerization process in which the first polymer is a first-stage polymer and the second polymer is a second-stage polymer, i.e., the second polymer is formed by emulsion polymerization in the presence of the first emulsion polymer, with at least two stages that are different in composition.

By the term “(meth)acrylic” as used is denoted all kind of acrylic and methacrylic monomers.

By the term “(meth)acrylic polymer” as used is denoted that the (meth)acrylic) polymer comprises essentially polymers comprising (meth)acrylic monomers that make up 50 wt % or more of the (meth) acrylic polymer.

By the term “dry” as used is denoted that the ratio of residual water is less than 1.5 wt and preferably less than 1.2 wt %.

By saying that a range from x to y in the present invention, it is meant that the upper and lower limit of this range are included, equivalent to at least x and up to y.

By saying that a range is between x and y in the present invention, it is meant that the upper and lower limit of this range are excluded, equivalent to more than x and less than y.

By the term “phr” are denoted parts per hundred parts by weight.

With easily dispersed in liquid resins is meant that a homogenous dispersion is obtained. The distribution of the polymeric composition (PC1) is not homogenous if separation takes place after initial homogenization.

With regard to the composition (C1) according to the invention, it comprises a) 100 parts a composition (C2) comprising of a monomer (M1) or a prepolymer (PRE1) and b) between 10 phr and 100 phr by weight of a polymeric composition (PC1).

Preferably the composition (C2) is liquid. By liquid is meant that the composition (C2) is liquid at least at a temperature range from 50° C. to 80° C., preferably from 40° C. to 80° C. and still more preferably from 20° C. to 80° C. This limitation means that the composition (C2) could be still liquid outside these ranges.

Preferably the composition (C1) is liquid. By liquid is meant that the composition (C1) is liquid at least at a temperature range from 50° C. to 80° C., preferably from 40° C. to 80° C. and still more preferably from 20° C. to 80° C. This limitation means that the composition (C1) could be still liquid outside these ranges, but is in the liquid phase in these ranges.

In a first preferred embodiment, the composition (C2) is comprising the monomer (M1).

In a second preferred embodiment, the composition (C2) is comprising the prepolymer (PRE1). In a variation of the second preferred embodiment, the composition (C2) is comprising the prepolymer (PRE1) and additionally a solvent.

In a third preferred embodiment, the composition (C2) is comprising a mixture of the monomer (M1) and the prepolymer (PRE1). In a variation of the third preferred embodiment, the composition (C2) is comprising a mixture of the monomer (M1), the prepolymer (PRE1) and additionally a solvent.

In a fourth preferred embodiment, the composition (C2) is a mixture of prepolymers (PRE1a) and (PRE1b).

In a fifth preferred embodiment, the composition (C2) is a mixture of prepolymers (PRE1a) and (PRE1b) and additionally a solvent.

In a sixth preferred embodiment, the composition (C1) is a mixture of prepolymers (PRE1a) and (PRE1b), monomer (M1) and additionally a solvent

The component a) composition (C2) alone is liquid at least at a temperature interval from 50° C. to 80° C. and is having a dynamic viscosity between 0.5 mPa*s and 1000 Pa*s.

In a first preferred embodiment, the composition (C1) comprises between 10 phr and 100 phr of a polymeric composition (PC1) for 100 parts of composition (C2), more preferably between 10 phr and 90 phr, still more preferably between 10 phr and 80 phr and advantageously between 10 phr and 75 phr.

In a second preferred embodiment, the composition (C1) comprises more than 25 phr of a polymeric composition (PC1) for 100 parts of polymeric composition (C2), preferably more than 30 phr, even more preferably more than 35 phr and advantageously between 35 phr and 100 phr of a polymeric composition (PC1) for 100 parts of polymeric composition (C2) comprising a monomer (M1) or a prepolymer (PRE1) or a mixture of both.

Preferably the composition (C1) is liquid at least at a temperature interval from 50° C. to 80° C. and is having a dynamic viscosity between 1 mPa*s and 20000 Pa*s.

The monomer (M1) of the polymeric composition (PC1), it is a liquid monomer at least in the temperature range between 10° C. and 60° C. The monomer (M1) comprises one carbon C═C double bond.

The monomer (M1) is preferably chosen from (meth)acrylic monomers and/or vinyl monomers and mixtures thereof. More preferably the monomer (M1) of the polymeric composition (PC1) is chosen from a (meth)acrylic monomer.

In a first preferred embodiment the monomer (M1) comprises at least 50 wt % of methyl methacrylate.

In a second preferred embodiment the monomer (M1) is a mixture of monomers that comprises at least 50 wt % of methyl methacrylate and the rest up too 100 wt % is chosen from C2 to C12 alkyl (meth)acrylates, alkyl acrylate, styrenic monomers and mixtures thereof.

In a third preferred embodiment the monomer (M1) comprises at least 80 wt % of methyl methacrylate.

In a forth preferred embodiment the monomer (M1) is a mixture of monomers that comprises at least 80 wt % of methyl methacrylate and the rest up too 100 wt % is chosen from C2 to C12 alkyl (meth)acrylates, alkyl acrylate, styrenic monomers and mixtures thereof.

In a fifth preferred embodiment the monomer (M1) comprises at least 90 wt % of methyl methacrylate.

In a sixth preferred embodiment the monomer (M1) is a mixture of monomers that comprises at least 90 wt % of methyl methacrylate and the rest up too 100 wt % is chosen from C2 to C12 alkyl (meth)acrylates, alkyl acrylate, styrenic monomers and mixtures thereof.

In a seventh preferred embodiment the monomer (M1) is methyl methacrylate only.

The prepolymer (PRE1) of the polymeric composition (C2) is preferably chosen from an epoxy resin. Preferably the epoxy resin is comprising at least two functional groups of oxirane type.

Preferably the prepolymer (PRE1) of the polymeric composition (PC1) comprises or is chosen from a liquid epoxy resin or a liquid mixture of epoxy resins.

The liquid epoxy resin can be based on bisphenol A or F or based on phenol novolaks or mixtures thereof in any proportion. They can be mixed with a reactive diluent, such as phenyl or cresyl glycidyl ether, butanediol diglycidyl ether, hexanediol diglycidyl ether or diglycidyl hexahydrophthalate, for example, preferably in an amount of 1-50 wt %, more preferably 2 to 40 wt %, based on the total amount of the epoxy resins as prepolymer (PRE1) of composition (C2).

In the case of the embodiment where the composition (C2) comprises a mixture of prepolymers (PRE1a) and (PRE1b), at least one of the two prepolymers of the mixture is an epoxy resin comprising at least two functional groups of oxirane type. The other prepolymer can comprise one functional groups of oxirane type, two as well or more. In the mixture of prepolymers (PRE1a) and (PRE1b), one of the prepolymers is preferably a glycidyl ether, and more preferably a diglycidyl ether comprising a linear aliphatic or cyclic aliphatic group.

The at least one prepolymer of the mixture comprising at least two functional groups of oxirane type in the following is called (PRE1a). The other prepolymer that can comprise one functional groups of oxirane type, two as well or more, in the following is called (PRE1b).

(PRE1a) is in access in the mixture of prepolymers (PRE1a) and (PRE1b). The weight ratio between (PRE1a)/(PRE1b) is between 99/1 and 60/40, preferably between 99/1 and 70/30.

Preferably the viscosity of (PRE1b) is lower than the viscosity of (PRE1a). The dynamic viscosity of (PRE1b) is preferably less than 1000 mPa*s at 25° C., more preferably between 1 and 800 mPa*s at 25° C., still more preferably between 1 and 500 mPa*s at 25° C. and advantageously between 1 and 250 mPas at 25° C.

In a first preferred embodiment (PRE1a) is a diglycidyl ether comprising aromatic groups and (PRE1b) is a glycidyl ether or glycidyl ester comprising a linear aliphatic or cyclic aliphatic group.

In a second preferred embodiment (PRE1a) is a diglycidyl ether comprising aromatic groups and (PRE1b) is a glycidyl ether comprising a linear aliphatic or cyclic aliphatic group.

In a third preferred embodiment (PRE1a) is a diglycidyl ether comprising aromatic groups and (PRE1b) is a diglycidyl ether comprising a linear aliphatic or cyclic aliphatic group.

The solvent of the a variation of the second and third preferred embodiment, and fourth and fifth preferred embodiment of the composition (C1) is chosen from a ketone, or an ester

The multistage polymer (MP1) of the polymeric composition (PC1) has at least two stages (SB1) and (SB2) respectively; and these two stages, comprising polymer (B1) and polymer (B2) respectively are different in their polymer composition.

The multistage polymer (MP1) is preferably in form of polymer particles PAR considered more or less as spherical particles. These polymers particles PAR are also called core-shell particles. The first stage forms the core, the second or all following stages form the respective shells. Such a multistage polymer (MP1) which is also called core-shell particle is preferred.

The particles PAR, comprised in the polymer composition (PC1) are the primary particles. The particles PAR have a weight average particle size (diameter) between 15 nm and 900 nm. Preferably the weight average particle size of the polymer particle is between 20 nm and 800 nm, more preferably between, more preferably between 25 nm and 600 nm, still more preferably between 30 nm and 550 nm, again still more preferably between 35 nm and 500 nm, advantageously between 40 nm and 400 nm, even more advantageously between 75 nm and 350 nm and advantageously between 80 nm and 300 nm.

The polymeric composition (PC1) comprises a multistage polymer (MP1) and polymer (B3). Said multistage polymer (MP1) comprises at least b1) one stage (SB1) comprising a polymer (B1) having a glass transition temperature below 10° C., and at least b2) one stage (SB2) comprising a polymer (B2) having a glass transition temperature of at least 60° C. The polymer (B3) having a glass transition temperature of at least 30° C. represents at most 40 wt % of the polymeric composition (PC1) based on b1), b2) and b3) only. Preferably the polymer (B3) represents at most 35 wt % of the composition based on b1), b2) and b3) only; more preferably at most 30 wt %, still more preferably less than 30 wt %, advantageously less than 25 wt % and more advantageously less than 20 wt %.

Preferably the polymer (B3) represents more than 4 wt % of the composition based on b1), b2) and b3) only. More preferably the polymer (B3) represents more than 5 wt % of the composition based on b1), b2) and b3) only; even more preferably more than 6 wt %, still more preferably more than 7 wt %, advantageously more than 8 wt % and more advantageously more than 10 wt %.

Preferably the polymer (B3) represents between 4 wt % and 40 wt % of the composition based on b1), b2) and b3) only. More preferably the polymer (B3) represents between 5 wt % and 35 wt % of the composition based on b1), b2) and b3) only; even more preferably between 6 wt % and 30 wt %, still more preferably between 7 wt % and less than 30 wt %, advantageously between 7 wt % and less than 25 wt % and more advantageously between 10 wt % and less than 20 wt %.

In a first preferred embodiment of the polymeric composition (PC1), the stage (SB1) is the first stage of the at least two stages and the stage (SB2) comprising polymer (B2) is grafted on stage (SB1) comprising polymer (B1) or another intermediate layer.

In a second preferred embodiment of the polymeric composition (PC1), there could also be another stage before stage (SB1), so that stage (SB1) would also be a shell.

In a third preferred embodiment of the polymeric composition (PC1), the polymer (B3) having a glass transition temperature of at least 30° C. is also part of the multistage polymer (MP1). There is also at least one stage (SB3). Preferably the stage (SB3) takes place after stage (SB2). More preferably stage (SB3) is the last stage and the polymer (B3) is the outer shell of the multistage polymer (MP1).

In a first embodiment the polymer (B1) having a glass transition temperature below 10° C. comprises at least 50 wt % of polymeric units coming from alkyl acrylate or alkyl acrylates and the stage (SB1) is the most inner layer of the polymer particle having the multilayer structure. In other words the stage (SB1) comprising the polymer (B1) is the core of the polymer particle.

With regard to the polymer (B1) of the first preferred embodiment, it is a (meth) acrylic polymer comprising at least 50 wt % of polymeric units coming from acrylic monomers. Preferably 60 wt % and more preferably 70 wt % of the polymer (B1) are acrylic monomers units.

The acrylic monomer in polymer (B1) comprises monomers chosen from C1 to C18 alkyl acrylates or mixtures thereof. More preferably acrylic monomer in polymer (B1) comprises monomers of C2 to C12 alkyl acrylic monomers or mixtures thereof Still more preferably acrylic monomer in polymer (B1) comprises monomers of C2 to C8 alkyl acrylic monomers or mixtures thereof.

The polymer (B1) can comprise a comonomer or comonomers which are copolymerizable with the acrylic monomer, as long as polymer (B1) is having a glass transition temperature of less than 10° C.

The comonomer or comonomers in polymer (B1) are preferably chosen from (meth)acrylic monomers and/or vinyl monomers.

Most preferably the acrylic or methacrylic comonomers of the polymer (B1) are chosen from methyl acrylate, propyl acrylate, isopropyl acrylate, butyl acrylate, tert-butyl acrylate, methyl methacrylate, ethyl methacrylate, butyl methacrylate and mixtures thereof, as long as polymer (B1) is having a glass transition temperature of less than 10° C.

In a specific embodiment polymer (B1) is a homopolymer of butyl acrylate.

More preferably the glass transition temperature Tg of the polymer (B1) comprising at least 70 wt % of polymeric units coming from C2 to C8 alkyl acrylate is between −100° C. and 10° C., even more preferably between −80° C. and 0° C. and advantageously between −80° C. and −20° C. and more advantageously between −70° C. and −20° C.

In a second preferred embodiment the polymer (B1) having a glass transition temperature below 10° C. comprises at least 50 wt % of polymeric units coming from isoprene or butadiene and the stage (SB1) is the most inner layer of the polymer particle having the multilayer structure. In other words the stage (SB1) comprising the polymer (B1) is the core of the polymer particle.

By way of example, the polymer (B1) of the core of the second embodiment, mention may be made of isoprene homopolymers or butadiene homopolymers, isoprene-butadiene copolymers, copolymers of isoprene with at most 98 wt % of a vinyl monomer and copolymers of butadiene with at most 98 wt % of a vinyl monomer. The vinyl monomer may be styrene, an alkylstyrene, acrylonitrile, an alkyl (meth)acrylate, or butadiene or isoprene. In a preferred embodiment the core is a butadiene homopolymer.

More preferably the glass transition temperature Tg of the polymer (B1) comprising at least 50 wt % of polymeric units coming from isoprene or butadiene is between −100° C. and 10° C., even more preferably between −90° C. and 0° C., advantageously between −80° C. and 0° C. and most advantageously between −70° C. and −20° C.

In a third preferred embodiment the polymer (B1) is a silicone rubber based polymer. The silicone rubber for example is polydimethyl siloxane. More preferably the glass transition temperature Tg of the polymer (B1) of the second embodiment is between −150° C. and 0° C., even more preferably between −145° C. and −5° C., advantageously between −140° C. and −15° C. and more advantageously between −135° C. and −25° C.

The polymer (B1) having a glass transition temperature below 10° C. comprises monomer units, that have been polymerized. The polymer (B1) in general and respective polymers (B1) of the first, second and third preferred embodiment are prepared from the respective monomer or monomer mixture (B1ₘ) yielding to the monomer units comprised polymer (B1).

With regard to the polymer (B2), mention may be made of homopolymers and copolymers comprising monomers with double bonds and/or vinyl monomers. Preferably the polymer (B2) is a (meth) acrylic polymer.

Preferably the polymer (B2) comprises at least 70 wt % monomers chosen from C1 to C12 alkyl (meth)acrylates. Still more preferably the polymer (B2) comprises at least 80 wt % of monomers C1 to C4 alkyl methacrylate and/or C1 to C8 alkyl acrylate monomers.

Most preferably the acrylic or methacrylic monomers of the polymer (B2) are chosen from methyl acrylate, ethyl acrylate, methyl methacrylate, ethyl methacrylate, butyl methacrylate and mixtures thereof, as long as polymer (B2) is having a glass transition temperature of at least 60° C.

Advantageously the polymer (B2) comprises at least 70 wt % of monomer units coming from methyl methacrylate.

Preferably the glass transition temperature Tg of the polymer (B2) is between 60° C. and 150° C. The glass transition temperature of the polymer (B1) is more preferably between 80° C. and 150° C., advantageously between 90° C. and 150° C. and more advantageously between 100° C. and 150° C.

Preferably the polymer (B2) is grafted on the polymer made in the previous stage.

In certain embodiments the polymer (B2) is crosslinked.

In one embodiment the polymer (B2) comprises a functional comonomer. The functional copolymer is chosen from acrylic or methacrylic acid, the amides derived from this acids, such as for example dimethylacrylamide, 2-methoxy-ethyl acrylate or methacrylate, 2-aminoethyl acrylate or methacrylate which are optionally quaternized, polyethylene glycol (meth) acrylates, water soluble vinyl monomers such as N-vinyl pyrrolidone or mixtures thereof. Preferably the polyethylene glycol group of polyethylene glycol (meth) acrylates has a molecular weight ranging from 400 g/mol to 10 000 g/mol.

The polymer (B2) having a glass transition temperature of at least 60° C. comprises monomer units, that have been polymerized. The polymer (B2) in general and in the respective embodiments is prepared from the respective monomers or monomer mixtures (B2ₘ) yielding to the monomer units comprised in polymer (B2).

With regard to the polymer (B3), it has a mass average molecular weight Mw of between 10 000 g/mol and 500 000 g/mol.

The polymer (B3), it has a mass average molecular weight Mw of more than 10 000 g/mol, preferably more than 10 500 g/mol, more preferably more than 11 000 g/mol, still more preferably more than 12 000 g/mol, advantageously more than 13 000 g/mol, more advantageously more than 14 000 g/mol and still more advantageously more than 15 000 g/mol.

The polymer (B3), it has a mass average molecular weight Mw below 500 000 g/mol, preferably below 450 000 g/mol, more preferably below 400 000 g/mol, still more preferably below 400 000 g/mol, advantageously below 350 000 g/mol, more advantageously below 300 000 g/mol and still more advantageously below 250 000 g/mol and most advantageously below 200 000 g/mol.

Preferably the mass average molecular weight Mw of polymer (B3) is between 10 500 g/mol and 450 000 g/mol, more preferable between 11 000 g/mol and 400 000 g/mol and even more preferably between 12 000 g/mol and 350 000 g/mol advantageously between 13 000 g/mol and 300 000 g/mol, more advantageously between 14 000 g/mol and 250 000 g/mol and most advantageously between 15 000 g/mol and 200 000 g/mol.

In a first advantageously embodiment the mass average molecular weight Mw of the polymer (B3) is between 10 500 g/mol and 200 000 g/mol, more preferable between 11 000 g/mol and 190 000 g/mol and even more preferably between 12 000 g/mol and 180 000 g/mol advantageously between 13 000 g/mol and 150 000 g/mol, more advantageously between 14 000 g/mol and 135 000 g/mol and most advantageously between 15 000 g/mol and 120 000 g/mol.

In a second advantageously embodiment the mass average molecular weight Mw of the polymer (B3) is between 15 000 g/mol and 450 000 g/mol, more preferable between 16 000 g/mol and 400 000 g/mol and even more preferably between 17 000 g/mol and 350 000 g/mol advantageously between 18 000 g/mol and 300 000 g/mol, more advantageously between 19 000 g/mol and 250 000 g/mol and most advantageously between 20 000 g/mol and 200 000 g/mol.

Preferably the polymer (B3) is a copolymer comprising (meth)acrylic monomers. More preferably the polymer (B3) is a (meth) acrylic polymer. Still more preferably the polymer (B3) comprises at least 70 wt % monomers chosen from C1 to C12 alkyl (meth)acrylates. Advantageously the polymer (B3) comprises at least 80 wt % of monomers C1 to C4 alkyl methacrylate and/or C1 to C8 alkyl acrylate monomers.

Preferably the glass transition temperature Tg of the polymer (B3) is between 30° C. and 150° C. The glass transition temperature of the polymer (B3) is more preferably between 40° C. and 150° C., advantageously between 45° C. and 150° C. and more advantageously between 50° C. and 150° C.

Preferably the polymer (B3) is not crosslinked.

Preferably the polymer (C1) is not grafted on any of the polymers (B1) or (B2), especially if it is part of the multistage polymer (MP1). By not grafted is meant that at least 50 wt % of the polymer (C1) in the multistage polymer (MP1) can be solubilized in a solvent of the polymer (B3).

In one embodiment the polymer (B3) comprises also a functional comonomer.

The functional comonomer has the formula (1)

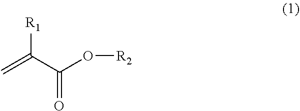

wherein R₁ is chosen from H or CH₃ and R₂ is H or an aliphatic or aromatic radical having at least one atom that is not C or H.

Preferably the functional monomer is chosen from glycidyl (meth)acrylate, acrylic or methacrylic acid, the amides derived from these acids, such as, for example, dimethylacrylamide, 2-methoxyethyl acrylate or methacrylate, 2-aminoethyl acrylates or methacrylates are optionally quaternized, polyethylene glycol (meth) acrylates. Preferably the polyethylene glycol group of polyethylene glycol (meth) acrylates has a molecular weight ranging from 400 g/mol to 10 000 g/mol.

In a first preferred embodiment the polymer (B3) comprises from 80 wt % to 100 wt % methyl methacrylate, preferably from 80 wt % to 99.9 wt % methyl methacrylate and from 0.1 wt % to 20 wt % of a C1 to C8 alkyl acrylate monomer. Advantageously the C1 to C8 alkyl acrylate monomer is chosen from methyl acrylate, ethyl acrylate or butyl acrylate.

In a second preferred embodiment the polymer (B3) comprises between 0 wt % and 50 wt % of a functional monomer. Preferably the meth)acrylic polymer (B3) comprises between 0 wt % and 30 wt % of the functional monomer, more preferably between 1 wt % and 30 wt %, still more preferably between 2 wt % and 30 wt %, advantageously between 3 wt % and 30 wt %, more advantageously between 5 wt % and 30 wt % and most advantageously between 5 wt % and 30 wt %.

Preferably the functional monomer of the second preferred embodiment is a (meth)acrylic monomer. The functional monomer has the formula (2) or (3)

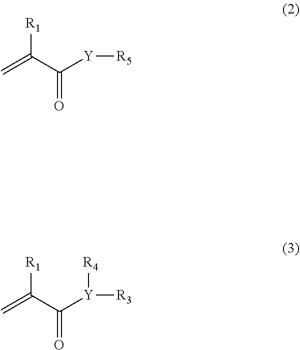

wherein in both formulas (2) and (3) R₁ is chosen from H or CH₃; and in formula (2) Y is O, R₅ is H or an aliphatic or aromatic radical having at least one atom that is not C or H; and in formula (3) Y is N and R₄ and/or R₃ is H or an aliphatic or aromatic radical.

Preferably the functional monomer (2) or (3) is chosen from glycidyl (meth)acrylate, acrylic or methacrylic acid, the amides derived from these acids, such as, for example, dimethylacrylamide, 2-methoxyethyl acrylate or methacrylate, 2-aminoethyl acrylates or methacrylates are optionally quaternized, acrylate or methacrylate monomers comprising a phosphonate or phosphate group, alkyl imidazolidinone (meth) acrylates, polyethylene glycol (meth) acrylates. Preferably the polyethylene glycol group of polyethylene glycol (meth) acrylates has a molecular weight ranging from 400 g/mol to 10 000 g/mol.

The polymer (B3) having a glass transition temperature of at least 30° C. comprises monomer units, that have been polymerized. The polymer (B3) in general and in the respective embodiments is prepared from the respective monomers or monomer mixtures (B3ₘ) yielding to the monomer units comprised polymer (B3).

The multistage polymer (MP1) is obtained by a multistage process comprising at least two stages. At least the component b1) and the component b2) of the polymeric composition (PC1) are part of a multistage polymer (MP1).

Preferably the polymer (B1) having a glass transition temperature below 10° C. made during the stage (SB1), is made before stage (SB2) or is the first stage of the multistage process.

Preferably the polymer (B2) having a glass transition temperature of at least 60° C. made during the stage (SB2) is made after the stage (SB1) of the multistage process.

In a first preferred embodiment the polymer (B2) having a glass transition temperature of at least 60° C. is an intermediate layer of the polymer particle having the multilayer structure.

In this first preferred embodiment the polymer (B3) having a glass transition temperature over 30° C. made during the stage (SB3), is made after the stage (SB2) of the multistage process.

More preferably the polymer (B3) having a glass transition temperature over 30° C. made during the stage (SB3) is the external layer of the multistage polymer (MP1) or the primary polymer particle having the multilayer structure.

There could be additional intermediate stages, either between stage (SB1) and stage (SB2) and/or between stage (SB2) and stage (SB3).

The polymer (B3) and the polymer (B2) are not the same polymer, even if their composition could be very close and some of their characteristics are overlapping. The essential difference is that the polymer (B2) is always part of the multistage polymer (MP1).

This is more explained in the process for preparing the polymeric composition (PC1) comprising the polymer (B3) and the multi stage polymer (MP1).

The weight ratio r of the polymer (B3) of the external layer comprised in stage (SB3) in relation to the complete polymer particle having the multilayer structure is at least 5 wt %, more preferably at least 7 wt % and still more preferably at least 10 wt %.

According to the invention the weight ratio r of the external stage (SB3) comprising polymer (B3) in relation to the complete polymer particle having the multilayer structure is at most 40 w %.

Preferably the weight ratio r of polymer (B3) in view of the primary polymer particle having the multilayer structure is between 5 wt % and 30 wt % and preferably between 10 wt % and 20 wt %.

In a second preferred embodiment the polymer (B2) having a glass transition temperature of at least 60° C. is the external layer of the primary polymer particle having the multilayer structure in other words the multistage polymer (MP1).

Preferably at least a part of the polymer (B2) of layer made during stage (SB2) is grafted on the polymer made in the previous layer. If there are only two stages (SB1) and (SB2) comprising polymer (B1) and (B2) respectively, a part of polymer (B2) is grafted on polymer (B1). More preferably at least 50 wt % of polymer (B1) is grafted. The ratio of grafting can be determined by extraction with a solvent for the polymer (B1) and gravimetric measurement before and after extraction to determine the non-grafted quantity.

The glass transition temperature Tg of the respective polymers can be estimated for example by dynamic methods as thermo mechanical analysis.

In order to obtain a sample of the respective polymers (B1), (B2) and (B3) they can be prepared alone under same conditions, but not by a multistage process, for estimating and measuring more easily the glass transition temperature Tg individually of the respective polymers of the respective stages. The polymer (B3) can be extracted for estimating and measuring the glass transition temperature Tg.

With regard to a first preferred process for manufacturing the polymer composition (PC1) it comprises the steps of
a) polymerizing by emulsion polymerization of a monomer or monomer mixture (B₁ₘ) to obtain one layer in stage (SB1) comprising polymer (B1) having a glass transition temperature of less than 10° C.,
b) polymerizing by emulsion polymerization of a monomer or monomer mixture (B₂ₘ) to obtain layer in stage (SB2) comprising a polymer (B2) having a glass transition temperature of at least 60° C.,
c) polymerizing by emulsion polymerization of a monomer or monomer mixture (B₃ₘ) to obtain a layer in stage (SB3) comprising a polymer (B3) having a glass transition temperature of at least 30° C.,
d) agglomerating the composition obtained in steps a) to c).

Preferably the step a) is made before step b).

More preferably step b) is performed in presence of the polymer (A1) obtained in step a).

Advantageously the first preferred process for manufacturing the polymer composition (PC1) is a multistep process that comprises the steps one after the other of:
a) polymerizing by emulsion polymerization of a monomer or monomer mixture (B₁ₘ) to obtain one layer in stage (SB1) comprising polymer (B1) having a glass transition temperature of less than 10° C.,
b) polymerizing by emulsion polymerization of a monomer or monomer mixture (B₂ₘ) to obtain layer in stage (SB2) comprising a polymer (B2) having a glass transition temperature of at least 60° C.
c) polymerizing by emulsion polymerization of a monomer or monomer mixture (B₃ₘ) to obtain a layer in stage (SB3) comprising a polymer (B3) having a glass transition temperature of at least 30° C.,
d) agglomerating the composition obtained in steps a) to c).

Preferably the steps a), b), c) and d) are performed in that order. As emulsion polymerization is used, the polymer composition at the end of the polymerization is obtained as an aqueous dispersion.

The respective monomers or monomer mixtures (B₁ₘ), (B₂ₘ) and (B₃ₘ) for forming the layers in the stages (SB1), (SB2) and (SB3) respectively comprising the polymers (B1), (B2) and (B3) respectively, are the same as defined before. The monomers or monomer mixtures (B₁ₘ), (B₂ₘ) and (B₃ₘ) comprise the respective monomers that are as polymerized monomer units in the polymer chain of the respective polymers (B1), (B2) and (B3). The characteristics of the polymers (B1), (B2) and (B3) respectively, are the same as defined before.

With regard to a second preferred process for manufacturing the polymeric composition (PC1) comprising the polymer (B3) and the multi stage polymer (MP1), it comprises the steps of
a) polymerizing by emulsion polymerization of a monomer or monomer mixture (B₁ₘ) to obtain one layer in stage (SB1) comprising polymer (B1) having a glass transition temperature of less than 10° C.,
b) polymerizing by emulsion polymerization of a monomer or monomer mixture (B₂ₘ) to obtain layer in stage (SB2) comprising a polymer (B2) having a glass transition temperature of at least 60° C., both together steps a) and b) giving a multistage polymer (MP1) and step c) blending multistage polymer (MP1) with a polymer (B3) having a glass transition temperature of at least 30° C.,
d) agglomerating the composition obtained in steps a) to c).

Preferably, the polymer (B3) is in form of an aqueous dispersion. The aqueous dispersion comprises the polymer (B3) in form of polymeric particles.

With regard to a third preferred process for manufacturing the polymeric composition (PC1) comprising the polymer (B3) and the multi stage polymer (MP1), it comprises the step of
a) providing a polymer (C1) having a glass transition temperature of at least 30° C. and a multistage polymer (MP1) comprising one stage (SB1) comprising a polymer (B1) having a glass transition temperature of less than 10° C. and one stage (SB2) comprising a polymer (B2) having a glass transition temperature of at least 60° C.,
b) mixing or blending of the polymer (B3) and the multi stage polymer (MP1),
c) agglomerating the composition obtained in steps b)
   wherein the polymer (B3) and the multi stage polymer (MP1) in step b) are in form of a dispersion in aqueous phase. The respective aqueous dispersions comprises the polymer (B3) and the multi stage polymer (MP1) in form of polymeric particles.

Preferably the multi stage polymer (MP1) and the polymer (B3) are already provided as an aqueous dispersion.

The agglomerating step of the respective processes for manufacturing the polymeric composition (PC1) can be chosen from coagulating or spray drying.

In a first preferred embodiment, the agglomerating step is made by coagulating in aqueous phase.

In a second preferred embodiment, the agglomerating step is made by spray drying.

The quantities of the aqueous dispersion of the polymer (B3) and the aqueous dispersion of the multi stage polymer (MP1) are chosen in a way that the weight ratio of the multi stage polymer based on solid part only in the obtained mixture is at least 60 wt %, preferably at least 65 wt %, more preferably at least 68 wt % and advantageously at least 70 wt %.

The quantities of the aqueous dispersion of the polymer (B3) and the aqueous dispersion of the multi stage polymer (MP1) are chosen in a way that the weight ratio of the multi stage polymer based on solid part only in the obtained mixture is at most 99 wt %, preferably at most 95 wt % and more preferably at most 90 wt %.

The quantities of the aqueous dispersion of the polymer (C1) and the aqueous dispersion of the multi stage polymer are chosen in a way that the weight ratio of the multi stage polymer based on solid part only in the obtained mixture is between 60 wt % and 99 wt %, preferably between 65 wt % and 95 wt % and more preferably between 68 wt % and 90 wt %.

The preferred processes for manufacturing the polymer composition (PC1) comprising the polymer (B3) and the multi stage polymer (MP1) yields to the polymer powder (POW1). The polymer powder (POW1) is in form of grains (large particles). The polymer powder grain or particle comprises agglomerated primary polymer particles made by multistage process comprising the multistage polymer (MP1) and the polymer (B3) or agglomerated primary polymer particles comprising the multistage polymer (MP1) and the polymer (B3) particles.

The component a) is a precursor for a thermosetting polymers or thermoplastic polymers. This can be a monomer (M1), a mixture of monomers, a prepolymer (PRE1) as a polymerizable or curable oligomer, a mixture of polymerizable or curable oligomer with monomer(s), or a mixture of polymers with monomer(s), which are liquid at 25° C. Preferably the liquid has a dynamic viscosity of less than 1000 Pa*s, and more preferably between 0.5 mPa*s and 1000 Pa*s. The value of the dynamic viscosity is taken at a shear rate of 1 l/s. The viscosity is measured with a rheometer.

The present invention relates also to a process for manufacturing the composition (C1) of the present invention.

The process for manufacturing the composition (C1) comprises the steps of:
a) providing the monomer (M1) or the prepolymer (PRE1);
b) providing a polymeric composition (PC1) comprising
   b1) one stage (SB1) comprising a polymer (B1) having a glass transition temperature of less than 10° C.,
   b2) one stage (SB2) comprising a polymer (B2) having a glass transition temperature of at least 60° C., and
   b3) and a polymer (B3) having a glass transition temperature of at least 30° C. and having a mass average molecular weight Mw between 10 000 g/mol and 500 000 g/mol, said polymer (B1) represents at most 40 wt % of the composition based on b1),
   b2) and b3) only,
c) bringing into contact the polymeric composition (PC1) with a resin (RES) comprising a monomer (M1) or a prepolymer (PRE1) or a mixture of both,
d) providing mixing means,
e) mixing the compounds brought into contact with the provided mixing means.

The quantity of polymeric composition (PC1) is chosen in a manner so that the composition (C1) comprises between 10 phr and 100 phr of a polymeric composition (PC1) for 100 parts of composition (C2) comprising a monomer (M1) or a prepolymer (PRE1) or a mixture of both.

In a first preferred embodiment, the polymeric composition (PC1) is in form of polymer powder.

Preferably the polymeric composition (PC1) is in form of polymer powder comprises no solvents. By no solvents is meant that eventually present solvent make up less than 1 wt % of the composition. The monomers of the synthesis of the respective polymers are not considered as solvents. The residual monomers in the composition present less than 2 wt % of the composition.

Preferably the polymeric composition (PC1) is in form of polymer powder is dry. By dry is meant that the polymer composition according to the present invention comprises less than 3 wt % humidity and preferably less than 1.5 wt % humidity and more preferably less than 1.2 wt % humidity.

The humidity can be measured by a thermo balance that heats the polymer composition and measures the weight loss.

Preferably the polymeric composition (PC1) is in form of polymer powder (POW1), it has a volume median particle size D50 between 1 μm and 700 μm. Preferably the volume median particle size of the polymer powder is between 10 μm and 600 μm, more preferably between 15 μm and 550 μm and advantageously between 20 μm and 500 μm.

The D10 of the particle size distribution in volume is at least 7 μm and preferably 10 μm, more preferably 15 μm.

The D90 of the particle size distribution in volume is at most 1000 μm and preferably 950 μm, more preferably at most 900 μm and even more preferably at most 800 μm.

Said process for manufacturing the composition (C1) comprises the step d) of providing mixing means.

Preferably the mixing means is a suitable equipment chosen from a three roll mill, high viscosity blenders, high shear mixers, acoustic mixers or planetary mixers.

In a first preferred embodiment the mixing means is a high shear mixer.

In a second preferred embodiment the mixing means is an acoustic mixer. “Acoustic mixer” is a term used to describe a broad-based machine that causes acoustic oscillations.

In a third preferred embodiment the mixing means is a planetary mixer. The planetary mixer comprises a mixing blade.

During the mixing step d) the temperature is between 15° C. and 150° C., preferably between 20° and 150° C., more preferably between 20° C. and 100° C. and still more preferably between 40° and 80° C.

The time of the mixing steps depends on the mixing means. In general, the time required for the mixing step is less than 2 hours.

The process for manufacturing the composition (C1) comprises optionally comprises the step preheating at least one of the provided components. Preferably the prepolymer (PRE1) is preheated before bring into contact the provided compounds of a) and b). The preheating temperature is at least 30° C., preferably at least 40° C. Advantageously the preheating temperature is between 40° C. and 150° C.

In a variation, the provided components of a) and b) are brought into contact in two or more distinctive steps. By this is meant that only a part of provided compound b) is brought into contact with provided components a) in as step c1). The two components are mixed in step e1) with the mixing means. Then the rest or again a further part of the compound a) is added in a second step c2) and then mixed in step e2). If only a part is added, then the steps c) and e) are repeated until all provided compound b) has been brought into contact. In this variation the step c) and e) are divided in several sub-steps c1) to cx) and e1) to ex), with x being the number of portions of to be added compound b).

Preferably this variation is used if the quantity of the components b) in the components a) is larger than 50 phr.

The composition (C1) of the invention can be used as a masterbatch.

The masterbatch can be used in different applications as adhesives, composites, wind blades, 3D printing, electronic (PCB or PCL) or sport.

The composition (C1) is mixed with another component or components in order to adapt the quantity of the polymeric composition (PC1).

The mixed composition is transformed to a polymer, by polymerization or curing.

The present invention also relates to a process to prepare a polymeric composition (PC2) from the composition (C1).

Said process comprises the following steps: polymerizing or curing the composition (C1).

The process to prepare a polymeric composition (PC2) from the composition (C1) comprises additionally the step of adding an additional quantity of composition (C2) before polymerizing or curing step.

### [Methods of Evaluation]

### Glass Transition Temperature

The glass transitions (Tg) of the polymers are measured with equipment able to realize a thermo mechanical analysis. A RDAII “RHEOMETRICS DYNAMIC ANALYSER” proposed by the Rheometrics Company has been used. The thermo mechanical analysis measures precisely the visco-elastics changes of a sample in function of the temperature, the strain or the deformation applied. The apparatus records continuously, the sample deformation, keeping the stain fixed, during a controlled program of temperature variation.

The results are obtained by drawing, in function of the temperature, the elastic modulus (G′), the loss modulus and the tan delta. The Tg is highest temperature value read in the tan delta curve, when the derivative of tan delta is equal to zero.

### Molecular Weight

The mass average molecular weight (Mw) of the polymers is measured with by size exclusion chromatography (SEC). Polystyrene standards are used for calibration. The polymer is dissolved in THF at a concentration of 1 g/L. The chromatography column uses modified silica. The flow is 1 ml/min and a detector for refractive index is used.

### Particle Size Analysis

The particle size of the primary particles after the multistage polymerization is measured with a Zetasizer from Malvern using dynamic light scattering. As result, the volume average particle size (diameter) is taken.

The particle size of the polymer powder after recovering is measured with Malvern Mastersizer 3000 from MALVERN with laser diffraction. For the estimation of weight average powder particle size, particle size distribution and ratio of fine particles a Malvern Mastersizer 3000 apparatus with a 300 mm lenses, measuring a range from 0.5-880 μm is used.

### Viscosity

The viscosity is the dynamic viscosity. If there should be shear thinning the value of the dynamic viscosity is taken at a shear rate of 1 l/s. The viscosity is measured with a rheometer from company Anton Parr. A rotational Rheometer type RheolabQC is used.

### Raw Materials Used

As a first prepolymer (PRE1) DGEBA (bisphenol A diglycidyl ether) is used.

As variation also mixtures of prepolymers as exemplified. In that case this would be the embodiment comprising (PRE1a) and (PRE1b); DGEBA as (PRE1a) and 1,6-hexanediol diglycidyl ether and 1,4-cyclohexanedimethanol diglycidyl ether respectively as (PRE1b).

A multistage polymer in form of core-shell particles CS2 comprising a polymer (B3) was prepared according WO2020/260637 as the product called core/shell-2.

A multistage polymer in form of core-shell particles CS1 are used as comparative product according to WO2020/260637 however performing only the first and second stage towards a product called core/shell-1 in experimental part WO2020/260637.

Composition prepared with process with mixing blade.

The core-shell particles CS1 and CS2 are respectively blended at 15 wt % in DGEBA in a reactor equipped with heating means and stirring means. The stirrer is a mixing blade.

TABLE 1
dynamic viscosity at 80° C. as function of mixing time.

Viscosity [Pa*s]

| Time [min] | CS1 | CS2 |
|---|---|---|
| 1 | 3.3 | 1.90 |
| 2 | 3.3 | 1.40 |
| 3 | 3.2 | 1.20 |
| 4 | 3.1 | 1.15 |
| 5 | 3.0 | 1.10 |
| 8 | 2.9 | 1.05 |
| 10 | 2.8 | 1.05 |
| 12 | 2.7 | 1.05 |
| 15 | 2.6 | 1.05 |
| 20 | 2.2 | 1.05 |
| 30 | 2.1 | 1.05 |
| 45 | 1.9 | 1.05 |

As can be seen in table 1 the preparation takes much longer in view of mixing time, when not preparing the composition according to the invention or with the process according to the invention.

Compositions are prepared as well with process with acoustic mixer. A resonant acoustic mixer (or “RAM mixer”) LabRAM from RESODYN™ Acoustic Mixers, Inc. (Butte, Mont.) or PCCA (Houston, Tex.) is used.

The core-shell polymers CS1 and CS2 as before are used as component b) polymeric composition (PC1). As component a) composition (C2) a DGEBA epoxy resin is used again.

The rough mixture of both components is preheated at 80° C. for 15 min. The RAM mixer is used for 1 min.

The CS1 is poorly dispersed at a quantity of 10 wt %, while a very good dispersion is obtained with CS2 at the same ratio. With CS2 a composition with even 21 wt % can be produced. When added in to steps a very good dispersion of CS2 at 38 wt % is obtained.

Compositions of CS2 in prepolymer (PRE1) are prepared as described before. This time mixtures of prepolymers (PRE1a) and (PRE1b), with DGEBA as (PRE1a) and 1,6-hexanediol diglycidyl ether as (PRE1b1) and 1,4-cyclohexanedimethanol diglycidyl ether as (PRE1b2) are used. The mixing ratio is respectively (PRE1a)/(PRE1b)=95/5 parts by weight. The obtained viscosities are given in table 2.

TABLE 2
viscosity at 25° C.

| CS2 | | | |
|---|---|---|---|
| concentration | Viscosity [Pa*s] | | |
| [wt %] | (PRE1) | (PRE1a)/(PRE1b1) | (PRE1a)/(PRE1b2) |
| 10 | 27 | 16 | 22 |
| 15 | 66 | 22 | 35 |
| 20 | 153 | 41 | 60 |
| 25 | 282 | 90 | 134 |
| 30 | 825 | 118 | 218 |

As shown in table 2, the use of the mixtures for the prepolymer (PRE1) allows to reduce lower viscosities for same quantity of core-shell particles or higher quantity at a comparable viscosity level.

A polymeric composition type (PC2) is prepared from the compositions (C1) of table 2 comprising 10 wt % of CS2. The compositions are cured with DDA.

TABLE 3
mechanical properties results of cured composition

| | (PRE1a)/ | (PRE1a)/ | Neat Epoxy |
|---|---|---|---|
| | (PRE1b1) | (PRE1b2) | system |
| K_{1c} | 1.5 | 1.3 | 0.68 |
| (MPa · m^{1/2}) | | | |
| G_{1c} | 2.3 | 2.5 | 0.53 |
| (kJ/m²) | | | |

In table 3 a significant increase in toughening is observed for a polymer obtained from a composition according to the invention. The fracture toughness increase significantly, as the crack growth resistance K_{1c} and the fracture toughness G_{1c} show.

1. A composition (C1) comprising:
a) 100 parts of a composition (C2) comprising a monomer (M1) or a prepolymer (PRE1) or a mixture of both,
b) between 10 phr and 100 phr of a polymeric composition (PC1) comprising
b1) one stage (SB1) comprising a polymer (1) having a glass transition temperature of less than 10° C.,
b2) one stage (SB2) comprising a polymer (B2) having a glass transition temperature of at least 60° C., and
b3) and a polymer (B3) having a glass transition temperature of at least 30° C., said polymer (B3) represents at most 40 wt % of the composition based on b1), b2) and b3) only;
characterized in that at least the component b1) and the component b2) of composition (PC1) are part of a multistage polymer (MP1), and characterized in that the polymer (B3) has a mass average molecular weight Mw between 10 000 g/mol and 500 000 g/mol.

2. The composition (C1) according to claim 1, characterized in that the composition (C2) is liquid at least at a temperature range from 5ho10° C. to 80° C.

3. The composition (C1) according to claim 1, characterized in that the composition (C1) is liquid at least at a temperature range from 50° C. to 80° C.

4. The composition (C1) according to claim 1, characterized in that the composition (C2) is comprising the prepolymer (PRE1).

5. The composition (C1) according to claim 1, characterized in that the composition (C2) is a mixture of prepolymers (PRE1a) and (PRE1b).

6. The composition (C1) according to claim 1, characterized in that the composition (C1) comprises between 10 phr and 90 phr of the polymeric composition (PC1) for 100 parts of composition (C2), still more preferably between 10 phr and 80 phr and advantageously between 10 phr and 75 phr.

7. The composition (C1) according to claim 1, characterized in that the composition (C1) comprises between 35 phr and 100 phr of a polymeric composition (PC1) for 100 parts of polymeric composition (C2).

8. The composition (C1) according to claim 1, characterized in that the monomer (M1) is chosen from (meth)acrylic monomers and/or vinyl monomers and mixtures thereof.

9. The composition (C1) according to claim 1, characterized in that the prepolymer (PRE1) is chosen from an epoxy resin.

10. The composition (C1) according to claim 1, characterized in that the composition (C2) is liquid at a temperature interval from 20° C. to 80° C. and is having a dynamic viscosity between 0.5 mPa*s and 1000 Pa*s.

11. The composition (C1) according to claim 1, characterized in that the composition (C1) is liquid least at a temperature interval from 20° C. to 80° C. and is having a dynamic viscosity between 1 mPa*s and 20000 Pa*s

12. The composition (C1) according to claim 1, characterized in that the multistage polymer (MP1) is in form of a core-shell particle having a weight average particle size between 15 nm and 900 nm.

13. The composition (C1) according to claim 1, characterized in that the polymer (B3) is a (meth)acrylic polymer.

14. The composition (C1) according to claim 1, characterized in that the composition (C2) comprises an epoxy resin can be based on bisphenol A or F or based on phenol novolaks or mixtures thereof.

15. The composition according to claim 5, characterized in that in the mixture of prepolymers (PRE1a) and (PRE1b), one of the prepolymers is preferably a glycidyl ether, and more preferably a diglycidyl ether comprising a linear aliphatic or cyclic aliphatic group.

16. The composition according to claim 5, characterized in that the ratio between (PRE1a)/(PRE1b) is between 99/1 and 60/40, preferably between 99/1 and 70/30).

17. A process for manufacturing the composition (C1) according to claim 1, comprising the steps of:
a) providing a composition (C2) comprising a monomer (M1) or a prepolymer (PRE1) or a mixture of both;
b) providing a polymeric composition (PC1) comprising
b1) one stage (SB1) comprising a polymer (1) having a glass transition temperature of less than 10° C.,
b2) one stage (SB2) comprising a polymer (B2) having a glass transition temperature of at least 60° C., and
b3) and a polymer (B3) having a glass transition temperature of at least 30° C., said polymer (B3) represents at most 40 wt % of the composition based on b1), b2) and b3) only;
c) bringing into contact the provided components of a) and b);
d) providing mixing means;
e) mixing the components of a) and b) with the provided mixing means;
characterized in that at least the component b1) and the component b2) of composition (PC1) are part of a multistage polymer (MP1), and characterized in that the polymer (B3) has a mass average molecular weight Mw between 10 000 g/mol and 500 000 g/mol; and characterized that the quantity of the polymeric composition (PC1) is chosen so that between 10 phr and 100 phr of a polymeric composition (PC1) are in composition (C1) for 100 parts of composition (C2) comprising monomer (M1) or a prepolymer (PRE1) or a mixture of both.

18. The process according to claim 17, characterized in that the temperature at the mixing step is between 15° and 150° C., preferably between 20° and 150° C., more preferably between 20° C. and 100° C. and still more preferably between 40° and 80° C.

19. The process according to claim 17, characterized in that the mixing means is chosen from high viscosity blenders, high shear mixers, acoustic mixers or planetary mixers

20. The process according to claim 17, characterized in that the bringing into contact the provided compounds of a) and b) is made in two distinctive steps.

21. The process according to claim 17, characterized that the time required for the mixing step is less than 2 hours.

22. The process according to claim 17, characterized in that the polymeric composition (PC1) is provided in form of a polymer powder having a volume median particle size D50 between 1 μm and 700 μm.

23. The process according to claim 17, characterized that the process comprises additionally the step of pre-heating.

24. Use of the composition (C1) according to claim 1 as a masterbatch.

25. Use of the composition (C1) according to claim 1 in applications as adhesives, composites, wind blades, 3D printing, electronic (PCB or PCL) or sport.

26. A process to reduce the dispersing time of between 10 phr and 100 phr of polymeric composition (PC1) comprising of a multistage polymer (MP1) comprising;
b1) one stage (1) comprising a polymer (1) having a glass transition temperature of less than 10° C.,
b2), one stage (B2) comprising a polymer (B2) having a glass transition temperature of at least 60° C.
in 100 parts of a composition (C2) comprising a monomer (M1) or a prepolymer (PRE1) or a mixture of both;
said process comprises the step of
i) bringing into contact the components
ii) providing mixing means
iii) mixing the components with the provided mixing means;
characterized in that the composition (PC1) comprises additionally b3) a polymer (B3) having a glass transition temperature of at least 30° C., said polymer (B3) represents at most 40 wt % of the composition based on b1), b2) and b3) only; and characterized in that the polymer (B3) has a mass average molecular weight Mw between 10 000 g/mol and 500 000 g/mol.

27. A process to reduce the time to prepare a masterbatch comprising between 10 phr and 100 phr of polymeric composition (PC1) comprising of a multistage polymer (MP1) comprising
b1) one stage (1) comprising a polymer (1) having a glass transition temperature of less than 10° C.,
b2), one stage (E2) comprising a polymer (E2) having a glass transition temperature of at least 60° C.
in 100 parts of a composition (C2) comprising a monomer (M1) or a prepolymer (PRE1);
said process comprises the step of
i) bringing into contact the components
ii) providing mixing means
iii) mixing the components with the provided mixing means;
characterized in that the composition (PC1) comprises additionally b3) a polymer (E3) having a glass transition temperature of at least 30° C., said polymer (B3) represents at most 40 wt % of the composition based on b1), b2) and b3) only; and characterized in that the polymer (B3) has a mass average molecular weight Mw between 10 000 g/mol and 500 000 g/mol.

28. A process to prepare a polymeric composition (PC2) from the composition (C1) according to claim 1, characterized in that the process comprises the following steps:
polymerizing or curing the composition (C1).

29. The process according to claim 28, characterized that the process comprises additionally the step of adding an additional quantity of composition (C2) before polymerizing or curing step.
